(19) United States
(12) Patent Application Publication
(10) Pub. No.: US 2026/0099256 A1
(43) Pub. Date: Apr. 9, 2026

(54) STORAGE DEVICE AND OPERATION METHOD THEREOF

(71) Applicant: Samsung Electronics Co., Ltd., Suwon-si (KR)

(72) Inventors: HAK NYUN KIM, Suwon-si (KR); JAEWOONG KIM, Suwon-si (KR)

(21) Appl. No.: 19/265,934

(22) Filed: Jul. 10, 2025

(30) Foreign Application Priority Data
Oct. 8, 2024 (KR) 10-2024-0136957

(51) Int. Cl. G06F 3/06

(52) U.S. Cl. CPC G06F 3/0616; G06F 3/0634; G06F 3/0679

(57) ABSTRACT

An operation method of a storage controller includes receiving a temperature of a storage device in a normal mode measured by a temperature sensor, sensing a temperature change slope of the storage device based on the temperature, and changing an operation mode of the storage device from the normal mode to a first limit mode, when the temperature change slope is greater than or equal to a reference slope. The first limit mode is a mode of selectively throttling a plurality of tasks which the storage device performs, and the temperature change slope of the storage device is periodically sensed.

### CROSS-REFERENCE TO RELATED APPLICATION

This application claims priority under 35 U.S.C. § 119 to Korean Patent Application No. 10-2024-0136957 filed on Oct. 8, 2024, in the Korean Intellectual Property Office, the entirety of which is incorporated by reference herein.

### BACKGROUND

A semiconductor memory is classified as a volatile memory, which loses data stored therein when a power is turned off, such as a static random access memory (SRAM) or a dynamic random access memory (DRAM), or a nonvolatile memory, which retains data stored therein even when a power is turned off, such as a flash memory, a phase-change RAM (PRAM), a magnetic RAM (MRAM), a resistive RAM (RRAM), or a ferroelectric RAM (FRAM).

A flash memory-based storage device (e.g., a solid state drive (SSD)) is widely used as a high-capacity storage medium of a computing system.

### SUMMARY

Some implementations according to the present disclosure provide storage devices with improved reliability and improved performance, and operation methods thereof.

In some cases, as the performance of a flash memory-based storage device is improved (e.g., as storage density increases), a temperature sharply increases while the storage device is operating. For purposes of this disclosure, it has been recognized that the increase in temperature of the storage device may cause a reduction in performance of the storage device. Some implementations according to this disclosure can provide devices, methods, and techniques for preventing or mitigating sharp increases in temperature of flash memory-based storage devices.

According to some implementations, an operation method of a storage controller includes receiving a temperature of a storage device in a normal mode measured by a temperature sensor, sensing a temperature change slope of the storage device based on the temperature, and changing an operation mode of the storage device from the normal mode to a first limit mode, when the temperature change slope is greater than or equal to a reference slope. The first limit mode is a mode of selectively throttling a plurality of tasks which the storage device performs, and the temperature change slope of the storage device is periodically sensed.

According to some implementations, an operation method of a storage controller includes receiving a temperature of a storage device in a normal mode measured by a temperature sensor, sensing a temperature change slope of the storage device based on the temperature, changing an operation mode of the storage device from the normal mode to a first limit mode, when the temperature change slope is greater than or equal to a reference slope, and selectively throttling a plurality of tasks performed in the first limit mode. The temperature change slope of the storage device is periodically sensed.

According to some implementations, a storage device includes a temperature sensor that measures a temperature of the storage device, and a storage controller that includes a mode manager configured to control an operation mode of the storage device. The mode manager receives a temperature of the storage device in a normal mode from the temperature sensor, senses a temperature change slope of the storage device based on the temperature of the storage device in the normal mode, and changes an operation mode of the storage device from the normal mode to a first limit mode, when the temperature change slope is greater than or equal to a reference slope. The first limit mode is a mode of selectively throttling a plurality of tasks which the storage device performs, and the temperature change slope storage device is periodically sensed.

### BRIEF DESCRIPTION OF THE FIGURES

FIG. 1 is a block diagram illustrating an example of a storage system.

FIG. 2 is a block diagram illustrating an example of a storage controller.

FIG. 3 is a flowchart illustrating an example of operation of a storage device.

FIGS. 4A and 4B are diagrams for illustrating operation S130 of FIG. 3.

FIG. 5 is a diagram for illustrating an operation mode of a storage device.

FIG. 6 is a flowchart illustrating an example of operation S150 of FIG. 3.

FIG. 7 is a diagram for illustrating operation S240 of FIG. 6.

FIG. 8 is a diagram for illustrating operation S250 of FIG. 6.

FIG. 9 is a flowchart illustrating an example of operation of a storage device.

FIG. 10 is a flowchart illustrating an example of operation of a storage device.

FIGS. 11A and 11B are diagrams for illustrating operation S430 of FIG. 10.

FIG. 12 is a flowchart illustrating an example of operation of a storage device.

FIG. 13 is a diagram for illustrating operation S530 of FIG. 12.

### DETAILED DESCRIPTION

In the detailed description and drawings, function blocks which are described or illustrated using the terms “unit”, “module”, etc., or which are illustrated in the drawings, may be implemented in the form of hardware, software, or a combination thereof, which is configured to perform a specific function.

FIG. 1 is a block diagram illustrating an example of a storage system. Referring to FIG. 1, a storage system 10 may include a host device 11 and a storage device 100. In some implementations, the storage system 10 is a computing system or an information processing system such as a computer, a notebook, a server, a workstation, a mobile phone, a personal digital assistant (PDA), a portable multimedia player (PMP), a smartphone, or a wearable IoT, or may be included therein.

The host device 11 may access the storage device 100. For example, based on a given host interface, the host device 11 may store data in the storage device 100 or may read data stored in the storage device 100. In some implementations, the given interface is an NVMe (Nonvolatile Memory express) interface, but the present disclosure is not limited thereto. For example, the given interface may include at least one of various interfaces such as an ATA (Advanced Technology Attachment) interface, an SATA (Serial ATA) interface, an e-SATA (external SATA) interface, an SCSI (Small Computer Small Interface) interface, an SAS (Serial Attached SCSI) interface, a PCI (Peripheral Component Interconnection) interface, a PCIe (PCI express) interface, an IEEE 1394 interface, an USB (Universal Serial Bus) interface, an SD (Secure Digital) card interface, an MMC (Multi-Media Card) interface, an eMMC (embedded Multi-Media Card) interface, an UFS (Universal Flash Storage) interface, an eUFS (embedded Universal Flash Storage) interface, a CF (Compact Flash) card interface, and a CXL (Compute eXpress Link) interface.

The storage device 100 may operate under control of the host device 11. For example, under control of the host device 11, the storage device 100 may store data or may output the stored data. In some implementations, the storage device 100 is a high-capacity storage device, which is configured to store data in a computing system, such as a solid state drive (SSD) or a universal flash storage (UFS) card, but the present disclosure is not limited thereto. For example, the storage device 100 may be a high-capacity storage medium included in a mobile system such as a mobile phone, a smartphone, a tablet personal computer (PC), a wearable device, a health care device, or an Internet of things (IoT) device. Alternatively, the storage device 100 may be a high-capacity storage medium included in a personal computer, a laptop computer, a server, a media player, an automotive device such as a navigation system, etc.

The storage device 100 may include a storage controller 110, a nonvolatile memory device 120, and a temperature sensor 130.

The storage controller 110 may control the nonvolatile memory device 120 under control of the host device 11. For example, under control of the host device 11, the storage controller 110 may store data in the nonvolatile memory device 120 or may read data stored in the nonvolatile memory device 120. For efficient operation of the storage device 100, the storage controller 110 may perform various maintenance operations (e.g., wear leveling, garbage collection, read reclaim, patrol read, periodic refresh, bad block management, and/or the like).

The nonvolatile memory device 120 may operate under control of the storage controller 110. For example, under control of the storage controller 110, the nonvolatile memory device 120 may store data or may output the stored data. In some implementations, the nonvolatile memory device 120 is a flash memory device. However, the present disclosure is not limited to flash memory as the nonvolatile memory device 120.

The temperature sensor 130 may measure a temperature of the storage device 100. For example, the temperature sensor 130 may provide the measured temperature of the storage device 100 to the storage controller 110.

According to some implementations of the present disclosure, the storage device 100 may control an operation mode of the storage device 100, based on the temperature measured by the temperature sensor 130. For example, based on the temperature measured by the temperature sensor 130, the storage controller 110 may change or maintain the operation mode of the storage device 100. The storage controller 110 may change the operation mode to control the performance of the storage device 100 or the task of the storage device 100.

In some implementations, the operation modes of the storage device 100 include a normal mode, a first limit mode, and a second limit mode.

The normal mode may refer to a mode in which the storage device 100 operates normally. For example, in the normal mode, the task of the storage device 100 may not be stopped. Alternatively, or in addition, in the normal mode, the performance of the storage device 100 may not be limited.

The first limit mode may refer to a mode for preventing a sharp increase in temperature of the storage device 100. For example, the storage device 100 in the first limit mode may refer to a mode of stopping some of the tasks of the storage device 100 or limiting a portion of the performance of the storage device 100 to prevent a sharp increase of temperature.

The second limit mode may refer to a mode for lowering a high temperature or high heat generation of the storage device 100. For example, the storage device 100 of the second limit mode may refer to a mode of stopping a whole task of the storage device 100 or limiting a whole performance of the storage device 100 to lower the high temperature or heat generation of the storage device 100.

The storage controller 110 may include a mode manager 113. The mode manager 113 may sense a temperature change slope of the storage device 100 based on the temperature measured by the temperature sensor 130. The mode manager 113 may control the operation mode of the storage device 100 based on the temperature change slope of the storage device 100. Alternatively, or in addition, the mode manager 113 may control the operation mode of the storage device 100 based on the temperature of the storage device 100 measured by the temperature sensor 130. For example, the mode manager 113 may change or maintain the operation mode of the storage device 100.

In some implementations, when the temperature change slope of the storage device 100 in the normal mode is greater than or equal to a reference slope, the mode manager 113 changes the operation mode of the storage device 100. For example, the mode manager 113 may change the operation mode of the storage device 100 from the normal mode to the first limit mode. A reference slope may be used as a reference for determining whether to change the operation mode of the storage device 100 from the normal mode to the first limit mode.

In some implementations, when the temperature of the storage device 100 in the first limit mode is greater than or equal to a first reference temperature, the mode manager 113 changes the operation mode of the storage device 100. For example, the mode manager 113 may change the operation mode of the storage device 100 from the first limit mode to the second limit mode. A first reference temperature may be used as a reference for determining whether to change the operation mode of the storage device 100 from the first limit mode to the second limit mode.

In some implementations, when the temperature of the storage device 100 in the first limit mode is smaller than the first reference temperature and is greater than or equal to a second reference temperature, the mode manager 113 may maintain the operation mode of the storage device 100. For example, the mode manager 113 may maintain the operation mode of the storage device 100, that is, may maintain the first limit mode of the storage device 100. The second reference temperature may be used as a reference for determining whether to change the operation mode of the storage device 100 from the first limit mode to the normal mode.

In some implementations, when the temperature of the storage device 100 in the first limit mode is lower than the second reference temperature, the mode manager 113 may change the operation mode of the storage device 100. For example, the mode manager 113 may change the operation mode of the storage device 100 from the first limit mode to the normal mode.

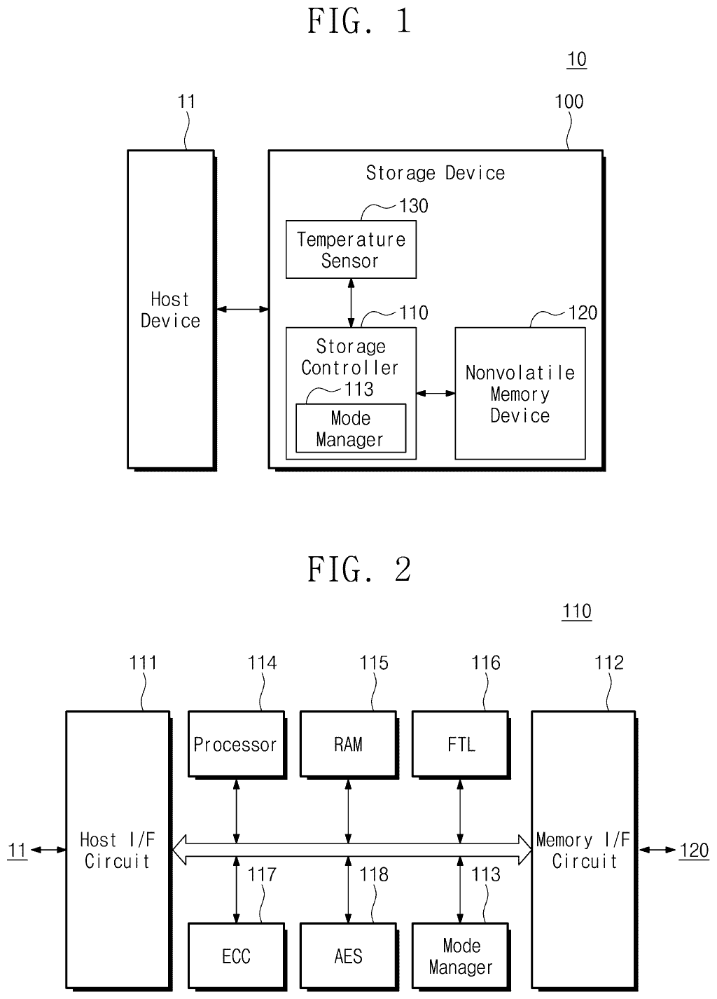

FIG. 2 is a block diagram illustrating an example of a storage controller of FIG. 1. Referring to FIGS. 1 and 2, the storage controller 110 may include a host interface circuit 111, a memory interface circuit 112, the mode manager 113, a processor 114, a random access memory (RAM) 115, a flash translation layer (FTL) 116, an error correction code (ECC) engine 117, and an advanced encryption standard (AES) engine 118.

The host interface circuit 111 may communicate with the host device 11. In some implementations, the host interface circuit 111 is configured to comply with a given interface, communication protocol, or communication standard between the host device 11 and the storage device 100. In some implementations, the host interface circuit 111 is configured to comply with the nonvolatile memory express (NVMe) standard. However, the present disclosure is not limited thereto.

The memory interface circuit 112 may communicate with the nonvolatile memory device 120. For example, the memory interface circuit 112 may access or control the nonvolatile memory device 120. For example, the memory interface circuit 112 may control the nonvolatile memory device 120 to read data stored in the nonvolatile memory device 120 or to write data in the nonvolatile memory device 120. In some implementations, the memory interface circuit 112 includes a flash controller configured to control the nonvolatile memory device 120. In some implementations, the memory interface circuit 112 is configured to comply with the given interface, communication protocol, or communication standard. The given interface, communication protocol, or communication standard may be a standard protocol such as toggle or ONFI, but the present disclosure is not limited to those protocols.

The mode manager 113 may sense a temperature change slope of the storage device 100 based on the temperature measured by the temperature sensor 130. The mode manager 113 may control the operation mode of the storage device 100 based on the temperature change slope of the storage device 100. For example, based on the temperature change slope of the storage device 100, the mode manager 113 may change or maintain the operation mode of the storage device 100.

The processor 114 may control all the operations of the storage controller 110. For example, the processor 114 may run various applications on the storage controller 110. The RAM 115 may be used as a working memory, a cache memory, or a buffer memory of the storage controller 110.

The FTL 116 may perform a maintenance task for efficiently managing or using the nonvolatile memory device 120. In some implementations, the maintenance task includes an address mapping operation, a wear-leveling operation, a garbage collection operation, etc.

The address mapping operation may refer to an operation of translating a logical address received from the host device 11 into a physical address. For example, the physical address may be used to actually store data in the nonvolatile memory device 120.

The wear-leveling operation may refer to an operation of preventing excessive degradation of a specific memory block among the memory blocks included in the nonvolatile memory device 120. For example, the FTL 116 may allocate the memory blocks included in the nonvolatile memory device 120 so as to be used uniformly, and thus, the excessive degradation of the specific memory block may be prevented. In some implementations, the wear-leveling operation of the FTL 116 is implemented through a firmware technology for balancing erase counts of the memory blocks of the nonvolatile memory device 120.

The garbage collection operation may refer to an operation of securing available blocks or capacity of the nonvolatile memory device 120. For example, the FTL 116 may copy valid data of a source memory block to a target memory block and may then erase the source memory block or may switch the source memory block to a free block.

The FTL 116 may further perform various management tasks such as read reclaim, patrol read, periodic read, bad block management, in addition to the above operations. In some implementations, some or all of the functions of the FTL 116 is implemented through software, hardware, or a combination thereof. Various maintenance tasks will be described in detail with reference to the following drawings.

The ECC engine 117 may perform an error detection and correction function for data read out from the nonvolatile memory device 120. For example, the ECC engine 117 may generate parity bits for write data to be written in the nonvolatile memory device 120, and the parity bits thus generated may be stored in the nonvolatile memory device 120 together with the write data. When data are read from the nonvolatile memory device 120, the ECC engine 117 may correct an error of the read data by using the parity bits read from the nonvolatile memory device 120 together with the read data and may output the error-corrected read data.

The AES engine 118 may perform at least one of an encryption operation and a decryption operation for data input to the storage controller 110 by using a symmetric-key algorithm.

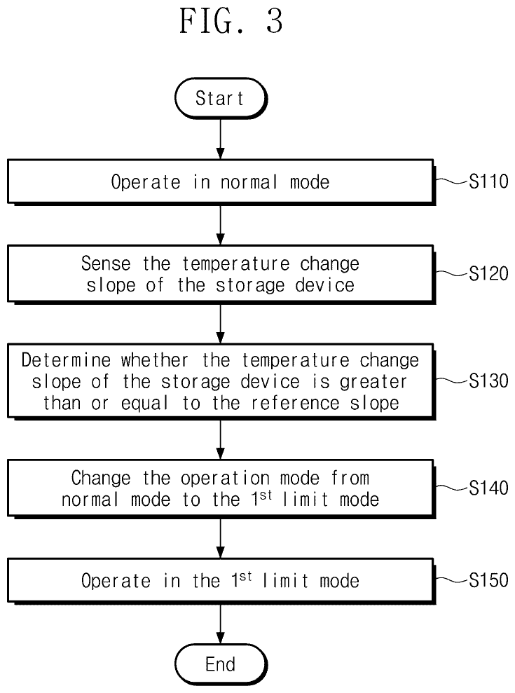

FIG. 3 is a flowchart illustrating an operation of a storage device of FIG. 1. In some implementations, the storage device may change the operation mode of the storage device from the normal mode to the first limit mode through the flowchart of FIG. 3. As the operation mode is changed to the first limit mode, the storage device may prevent a sharp increase in temperature of the storage device.

Referring to FIGS. 1, 2, and 3, in operation S110, the storage device 100 may operate in the normal mode. The normal mode may refer to a mode in which the storage device 100 operates normally. For example, in the normal mode, task(s) of the storage device 100 may not be stopped, e.g., stopped in response to temperature measurement. Alternatively, or in addition, in the normal mode, performance of the storage device 100 may not be limited, e.g., limited in response to temperature measurement.

In operation S120, the storage device 100 may sense the temperature change slope of the storage device 100. For example, the mode manager 113 may sense the temperature change slope of the storage device 100 based on the temperature of the storage device 100 measured by the temperature sensor 130. The mode manager 113 may periodically sense the temperature change slope.

In operation S130, the storage device 100 may determine whether the temperature change slope of the storage device 100 is greater than or equal to the reference slope. For example, the mode manager 113 may determine whether the temperature change slope of the storage device 100 is greater than or equal to the reference slope. The reference slope may be used as a reference for determining whether to change the operation mode of the storage device 100. For example, the reference slope may be used as a reference for determining whether to change the operation mode of the storage device 100 from the normal mode to the first limit mode.

When the temperature change slope of the storage device 100 in the normal mode is greater than or equal to the reference slope, in operation S140, the storage device 100 may change the operation mode of the storage device 100 to the first limit mode. For example, the mode manager 113 may change the operation mode of the storage device 100 from the normal mode to the first limit mode.

In operation S150, the storage device 100 may operate in the first limit mode. As the operation mode is changed to the first limit mode, the storage device 100 may prevent or reduce a sharp increase in temperature of the storage device 100. For example, the first limit mode of the storage device 100 may refer to a mode of stopping some of the tasks of the storage device 100 or limiting a portion of the performance of the storage device 100 to prevent or reduce the sharp increase of temperature.

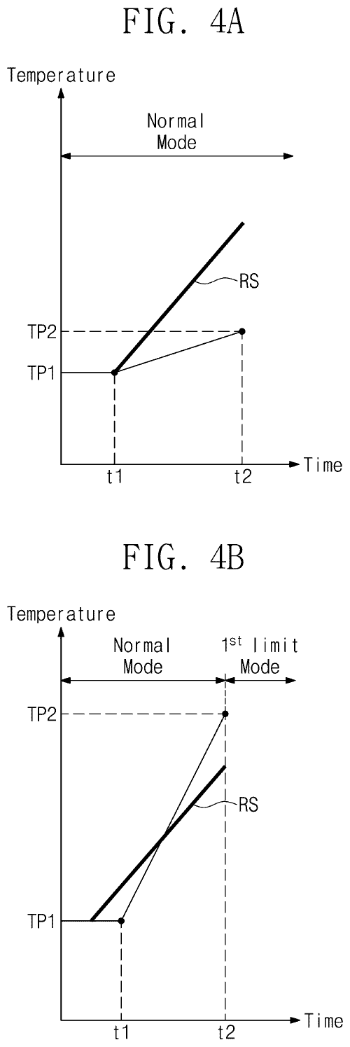

FIGS. 4A and 4B are diagrams for describing operation S130 of FIG. 3. In the graphs of FIGS. 4A and 4B, the horizontal axis represents time, and the vertical axis represents a temperature of a storage device.

Below, for convenience of description, it is assumed that the temperature increases as the storage device performs an operation or a task. However, the present disclosure is not limited thereto. For example, the storage device may operate in various ways depending on various use environments and/or a user/use scenarios.

Referring to FIGS. 1, 3, and 4A, the storage device 100 may operate in the normal mode at a first temperature TP1. For example, the first temperature TP1 may be a temperature before the storage device 100 operates or generates heat. For example, at a first time point t1, the storage device 100 may be in a state of operating in the normal mode. The normal mode may refer to a mode in which the storage device 100 operates normally.

At a second time point t2, the storage device 100 may sense a temperature change slope. For example, the mode manager 113 may sense the temperature change slope of the storage device 100 based on the temperature of the storage device 100 measured by the temperature sensor 130. A time interval from t1 to t2 may be used as a period in which the mode manager 113 senses the temperature change slope.

When the temperature change slope of the storage device 100 does not exceed a reference slope RS, as shown in FIG. 4A, the storage device 100 may maintain the operation mode. For example, the mode manager 113 may maintain the normal mode as the operation mode. That is, the mode manager 113 may not change the operation mode. For example, at the second time point t2, the storage device 100 may be in a state of operating normally in the normal mode.

Referring to FIGS. 1, 3, and 4B, at the first time point t1, the storage device 100 may be in a state of operating in the normal mode.

At the second time point t2, the mode manager 113 may sense the temperature change slope of the storage device 100 based on the temperature of the storage device 100 measured by the temperature sensor 130.

When the temperature change slope of the storage device 100 is greater than or equal to the reference slope RS, the storage device 100 may change the operation mode. For example, at the second time point t2, the mode manager 113 may change the operation mode from the normal mode to the first limit mode. To prevent the temperature of the storage device 100 from sharply increasing, in the first limit mode, the storage device 100 may stop one or more tasks of the storage device 100 and/or may limit a portion of the performance of the storage device 100.

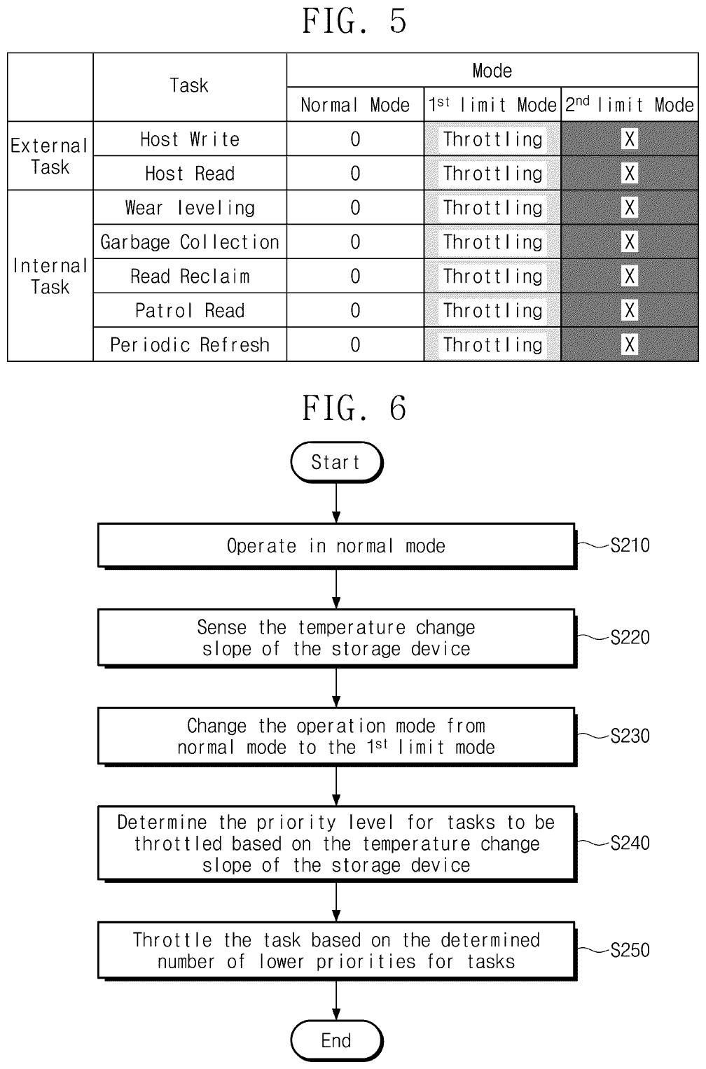

FIG. 5 is a diagram for describing an operation mode of a storage device of FIG. 1. Some of the tasks of the storage device to be described with reference to FIG. 5 are provided as an example, but the tasks are not limited thereto, and the storage device need not feature all of the illustrated tasks.

The tasks which the storage device performs will be described with reference to FIGS. 1, 2, and 5. A task which the storage device 100 performs may be classified as an external task or an internal task.

The external task may mean a task which the storage device 100 performs under control of the host device 11. For example, the task which is performed under control of the host device 11 may include a task of storing data, which is referred to as “host write”, or a task of outputting the stored data, which is referred to as “host read”, but the present disclosure is not limited thereto.

The internal task may mean a task in which the storage device 100 internally performs. For example, the internal task may include various maintenance tasks which the storage device 100 performs for the efficient operation of the storage device 100. The various maintenance tasks may include wear-leveling, garbage collection, read reclaim, patrol read, periodic refresh, etc., but the present disclosure is not limited thereto.

In the normal mode, the storage device 100 may normally perform the external task and the internal task. For example, the storage device 100 which operates in the normal mode may perform all the tasks illustrated in FIG. 5 without limiting performance or stopping a task.

In the first limit mode, the storage device 100 may throttle some of the external tasks and/or the internal tasks. For example, that a task is throttled may mean that the storage device 100 stops some tasks or limits a portion of the performance of task. By the throttling, the storage device 100 may prevent the sharp increase in temperature of the storage device 100.

In the second limit mode, the storage device 100 may stop all the tasks. For example, in the second limit mode, the storage device 100 may stop both the internal task and the external task. As all the tasks are stopped, the storage device 100 may lower the high temperature of the storage device 100.

FIG. 6 is a flowchart illustrating operation S150 of FIG. 3 in detail.

Referring to FIGS. 1, 2, 3, and 6, in operation S210, the storage device 100 may operate in the normal mode. In operation S220, the temperature sensor 130 may measure the temperature of the storage device 100 so as to be provided to the mode manager 113. The mode manager 113 may sense the temperature change slope of the storage device 100 in the normal mode. When the temperature change slope of the storage device 100 in the normal mode is greater than or equal to the reference slope, in operation S230, the mode manager 113 may change the operation mode of the storage device 100 from the normal mode to the first limit mode.

In operation S240, the storage device 100 may determine a priority level based on which to throttle tasks. For example, a priority of a task which the storage device 100 performs may be determined based on the importance of the task for operation of the storage device 100. For example, the priority of a task which the storage device 100 must perform to operate properly or which has a great influence on the storage device 100 may be high (e.g., may correspond to a higher priority). However, the priority of a task which the storage device 100 selectively performs or which has little or no negative influence on the storage device 100 when not performed may be lower (e.g., may correspond to a lower priority).

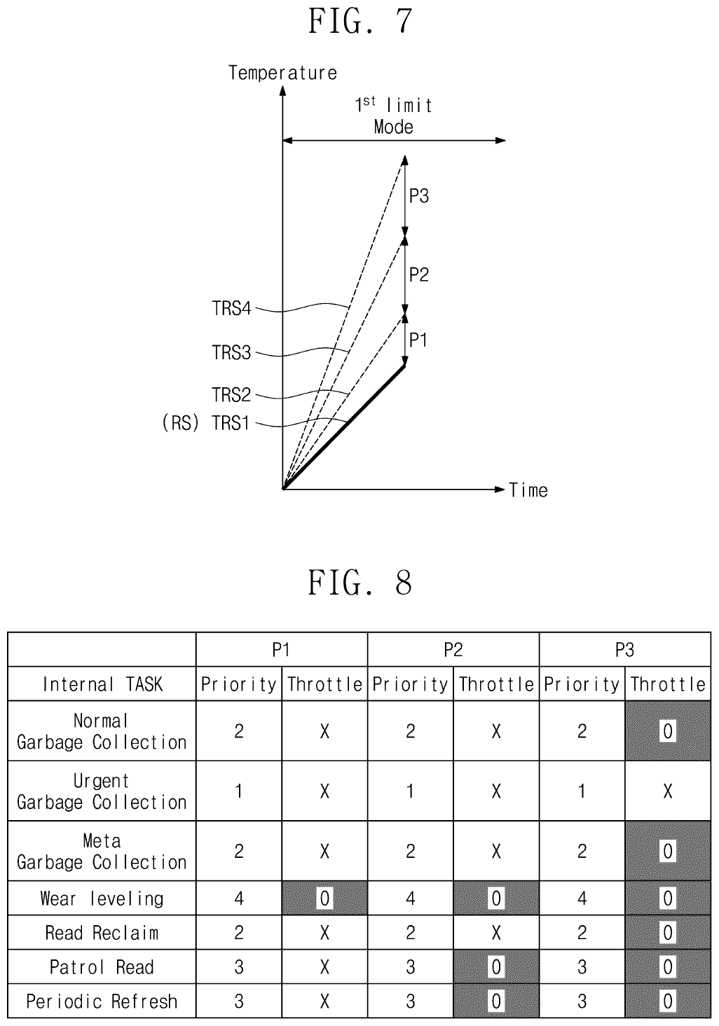

The storage device 100 may determine a priority level based on the temperature change slope of the storage device 100. For example, the temperature change slope of the storage device 100 may be classified depending on a range in which the temperature change slope falls. In some implementations, the storage device 100 determines the priority level as a priority level corresponding to a range to which the temperature change slope of the storage device 100 belongs. Operations of determining the priority level will be described with reference to FIGS. 7 and 8.

In operation S250, the storage device 100 may throttle the task based on the priority level thus determined. For example, the storage controller 110 may throttle tasks having priority levels less than or equal to the determined priority level. For example, the storage controller 110 may stop the tasks having the lower or equal priorities or may limit the performance thereof.

FIG. 7 is a diagram for describing operation S240 of FIG. 6. Some examples of a throttling reference slope are illustrated in FIG. 7 as an example, but the present disclosure is not limited thereto. Below, the description will be given for a scenario in which the storage device operates in the first limit mode.

Referring to FIGS. 1, 2, 6, and 7, first to fourth throttling reference slopes TRS1 to TRS4 are illustrated. The first to fourth throttling reference slopes TRS1 to TRS4 may be used as a reference for determining the priority level in the first limit mode. The priority level may be used to determine a task to be throttled. In some implementations, the first throttling reference slope TRS1 may be the same as the reference slope RS of FIG. 4A or 4B. However, the present disclosure is not limited thereto. For example, first to fourth throttling reference slopes TRS1 to TRS4 are illustrated in FIG. 7, but the number of throttling reference slopes may be different from four.

The storage device 100 may determine the priority level based on the first to fourth throttling reference slopes TRS1 to TRS4.

In some implementations, when the temperature change slope of the storage device 100 belongs to a first range P1 between the first throttling reference slope TRS1 and the second throttling reference slope TRS2, it may be determined that the priority level for throttling is one. The storage device 100 may throttle tasks having priority levels less than or equal to this priority level.

In some implementations, when the temperature change slope of the storage device 100 belongs to a second range P2 between the second throttling reference slope TRS2 and the third throttling reference slope TRS3, it may be determined that the priority level for throttling is two. The storage device 100 may throttle tasks having priority levels less than or equal to this priority level.

In some implementations, when the temperature change slope of the storage device 100 belongs to a third range P3 between the third throttling reference slope TRS3 and the fourth throttling reference slope TRS4, it may be determined that the priority level for throttling is three. The storage device 100 may throttle tasks having priority levels less than or equal to this priority level.

For example, as the temperature change slope of the storage device 100 becomes greater, the priority level for throttling may increase, and the number of tasks which the storage device 100 will throttle may increase.

FIG. 8 is a diagram for describing operation S250 of FIG. 6. Below, for convenience, the description will be given for a scenario in which the storage device operates in the first limit mode. According to the convention of FIG. 8, higher numbers in the “Priority” column correspond to lower priority levels. For example, “Wear leveling,” which has a “Priority” of 4, is a lower-priority task than “Meta Garbage Collection,” which has a “Priority” of 2.

Referring to FIGS. 1, 2, 6, 7, and 8, kinds of internal tasks which the storage device 100 performs, priorities (or priority levels) of the internal tasks, and whether to throttle the internal tasks are illustrated. For convenience of the description, an operation in which a storage device throttles an internal task will be described. Also, the kinds of the internal tasks and the priorities of the internal tasks are provided as an example, and the present disclosure is not limited thereto.

The storage device 100 may determine the priority level for throttling based on the temperature change slope of the storage device 100. The storage device 100 may throttle internal tasks corresponding to the number of lower priorities thus determined.

In some implementations, when the temperature change slope of the storage device 100 belongs to the first range P1 of FIG. 7, the priority level for throttling may be four. This priority level may be a lowest priority level. Tasks having a priority level of four may be throttled. In some implementations, as shown in FIG. 8, one task (a wear-leveling task) has a priority level of four. The storage device 100 may throttle the internal task (wear leveling) thus determined.

In some implementations, when the temperature change slope of the storage device 100 belongs to the second range P2 of FIG. 7, the priority level for throttling may be three. For example, tasks having a priority level of three or four may be throttled. In some implementations, as shown in FIG. 8, internal tasks having priority levels of three or four include the patrol read task, the periodic refresh task, and the wear-leveling task. The storage device 100 may throttle the internal tasks thus determined.

In some implementations, when the temperature change slope of the storage device 100 belongs to the third range P3 of FIG. 7, the priority level for throttling may be two. For example, tasks having a priority level of two, three, or four may be throttled. In some implementations, as shown in FIG. 8, internal tasks having the priority levels of two, three, or four include the normal garbage collection task, the meta garbage collection task, the read reclaim task, the patrol read task, the periodic refresh task, and the wear-leveling task. The storage device 100 may throttle the internal tasks thus determined.

Accordingly, when higher temperature change slopes are detected, higher-priority tasks may be throttled, reflecting an increased urgency to mitigate sharp temperature increases.

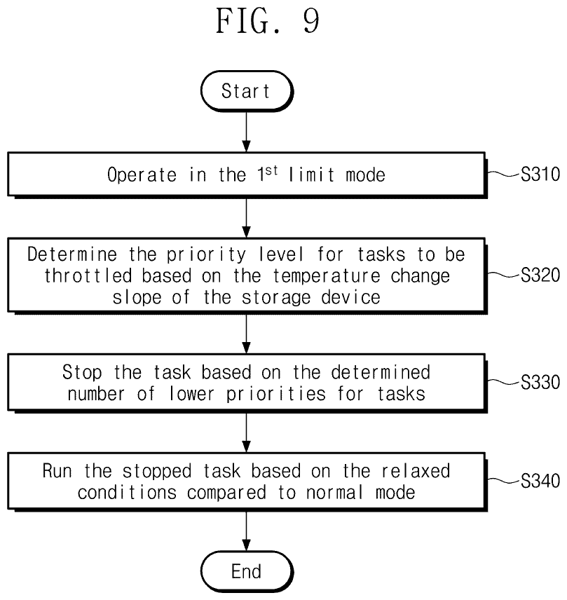

FIG. 9 is a flowchart illustrating an operation of a storage device of FIG. 1. Through the flowchart of FIG. 9, in the first limit mode, the storage device may stop one or more task(s) based on the priority level and may again run the stopped task(s) when a task running condition is satisfied.

Referring to FIGS. 1, 2, and 9, in operation S310, the storage device 100 may operate in the first limit mode. In operation S320, the storage device 100 may determine a priority level based on which to throttle tasks, based on the temperature change slope of the storage device 100.

In operation S330, the storage device 100 may throttle one or more task(s) based on the number of lower priorities thus determined. For example, the storage device 100 may stop a task(s) based on the number of lower priorities thus determined.

In operation S340, the storage device 100 may run the stopped task(s). For example, when the task running condition is satisfied, the storage device 100 may run the stopped task(s). The task running condition may be differently set for each task. For example, a running condition of the stopped garbage collection task may be a condition where the number of free blocks of the nonvolatile memory device 120 is less than or equal to a given value. For example, when the running condition of the stopped garbage collection task is satisfied, the storage device 100 may run the stopped garbage collection task.

The task running condition in the first limit mode may be an alleviated condition compared to the task running condition in the normal mode. For example, the running condition of the garbage collection task in the normal mode may be a condition where the number of free blocks of the nonvolatile memory device 120 is less than or equal to 100. In contrast, the running condition of the garbage collection task in the first limit mode may be a condition where the number of free blocks of the nonvolatile memory device 120 is less than or equal to 20. However, the present disclosure is not limited thereto.

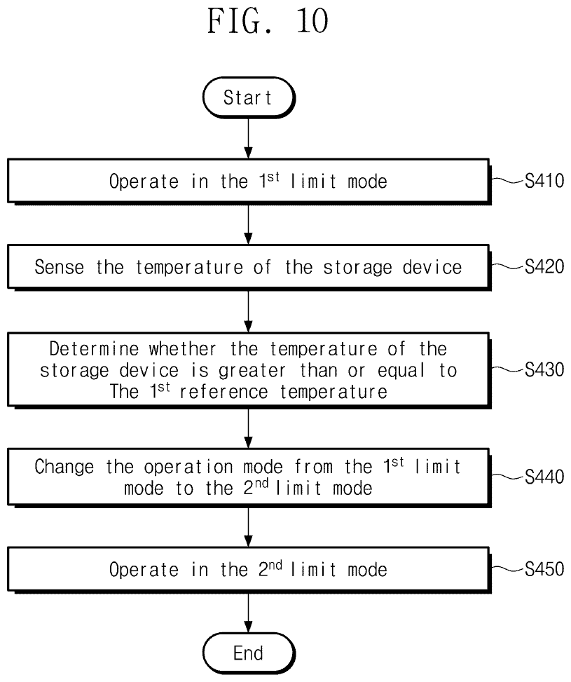

FIG. 10 is a flowchart illustrating an operation of a storage device of FIG. 1. Through the flowchart of FIG. 10, the storage device 100 may change the operation mode of the storage device 100 from the first limit mode to the second limit mode. As the operation mode is changed to the second limit mode, the whole performance of the storage device 100 may be limited, or the whole task which the storage device 100 performs may be stopped, or entire operation of the storage device 100 may be stopped.

Referring to FIGS. 1, 2, and 10, in operation S410, the storage device 100 may operate in the first limit mode. In operation S420, the temperature sensor 130 may measure the temperature of the storage device 100 so as to be provided to the mode manager 113.

In operation S430, the mode manager 113 may determine whether the temperature of the storage device 100 measured by the temperature sensor 130 is greater or equal to the first reference temperature. The first reference temperature may be used as a reference for determining whether to change the operation mode of the storage device 100 from the first limit mode to the second limit mode.

When the temperature of the storage device 100 is greater than or equal to the first reference slope, in operation S440, the storage device 100 may change the operation mode. For example, the mode manager 113 may change the operation mode from the first limit mode to the second limit mode. For example, the storage device 100 may change the operation mode of the storage device 100 from the first limit mode to the second limit mode to lower the high temperature or heat generation of the storage device 100.

In operation S450, the storage device 100 may operate in the second limit mode. The second limit mode may refer to a mode for lowering a high temperature or high heat generation of the storage device 100. Alternatively, or in addition, the second limit mode may refer to a mode in which the whole task performed by the storage device 100, or all operation of the storage device 100, is stopped. For example, in the second limit mode, to lower the high temperature or heat generation of the storage device 100, the storage device 100 may stop the whole task of the storage device 100, may stop or limit operation of the storage device 100, or may limit the whole performance of the storage device 100.

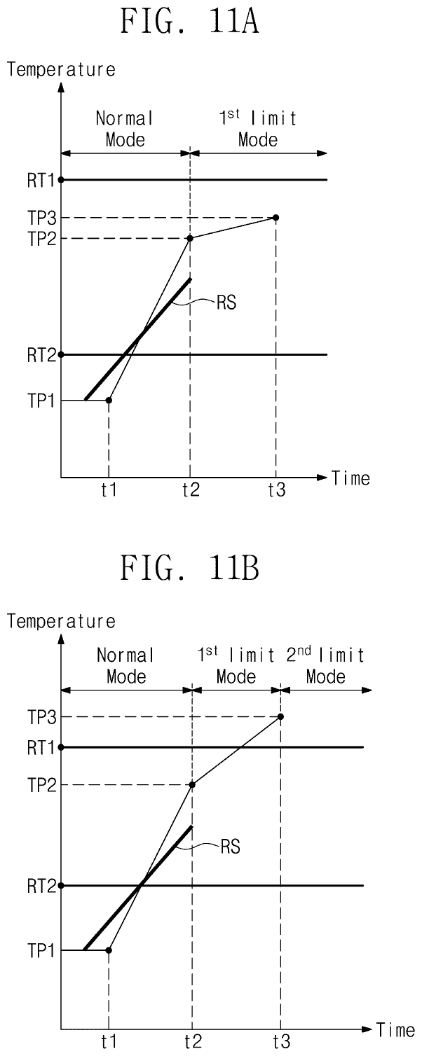

FIGS. 11A and 11B are diagrams for describing operation S430 of FIG. 10. In the graphs of FIGS. 11A and 11B, the horizontal axis represents a time, and the vertical axis represents a temperature of a storage device. Time intervals between first, second, and third time points t1, t2, and t3 may be periods in which a temperature sensor measures a temperature of the storage device.

Below, for convenience of description, it is assumed that temperature increases as the storage device performs an operation or a task. However, the present disclosure is not limited thereto. For example, the storage device may operate in various ways depending on various use environments and/or a user/use scenarios.

Referring to FIGS. 1, 2, 10, and 11A, at the first time point t1, the storage device 100 may operate in the normal mode. At the second time point t2, the storage device 100 may sense the temperature change slope of the storage device 100; when the temperature change slope of the storage device 100 is greater than or equal to the reference slope RS, the storage device 100 may change the operation mode of the storage device 100 from the normal mode to the first limit mode.

At the third time point t3, the temperature sensor 130 may measure the temperature of the storage device 100 in the first limit mode so as to be provided to the mode manager 113. The mode manager 113 may determine whether the temperature of the storage device 100 in the first limit mode measured by the temperature sensor 130 is greater than or equal to a first reference temperature RT1.

When the temperature of the storage device 100 in the first limit mode measured at the third time point t3 is smaller than the first reference temperature RT1 and is greater than or equal to a second reference temperature RT2, the mode manager 113 may maintain the operation mode of the storage device 100. That is, the mode manager 113 may not change the operation mode of the storage device 100. After the third time point t3, the storage device 100 may continue to operate in the first limit mode.

Referring to FIGS. 1, 2, 10, and 11B, at the first time point t1, the storage device 100 may operate in the normal mode. At the second time point t2, the storage device 100 may sense the temperature change slope of the storage device 100; when the temperature change slope of the storage device 100 is greater than or equal to the reference slope RS, the storage device 100 may change the operation mode of the storage device 100 from the normal mode to the first limit mode.

At the third time point t3, the temperature sensor 130 may measure the temperature of the storage device 100 in the first limit mode so as to be provided to the mode manager 113. The mode manager 113 may determine whether the temperature of the storage device 100 in the first limit mode measured by the temperature sensor 130 is greater than or equal to the first reference temperature RT1.

When the temperature of the storage device 100 in the first limit mode measured at the third time point t3 is greater than or equal to the first reference temperature RT1, the mode manager 113 may change the operation mode of the storage device 100. The mode manager 113 may change the operation mode of the storage device 100 from the first limit mode to the second limit mode. After the third time point t3, the storage device 100 may operate in the second limit mode. For example, in the second limit mode, to lower the high temperature or heat generation of the storage device 100, the storage device 100 may stop the whole task of the storage device 100 or may limit the whole performance of the storage device 100.

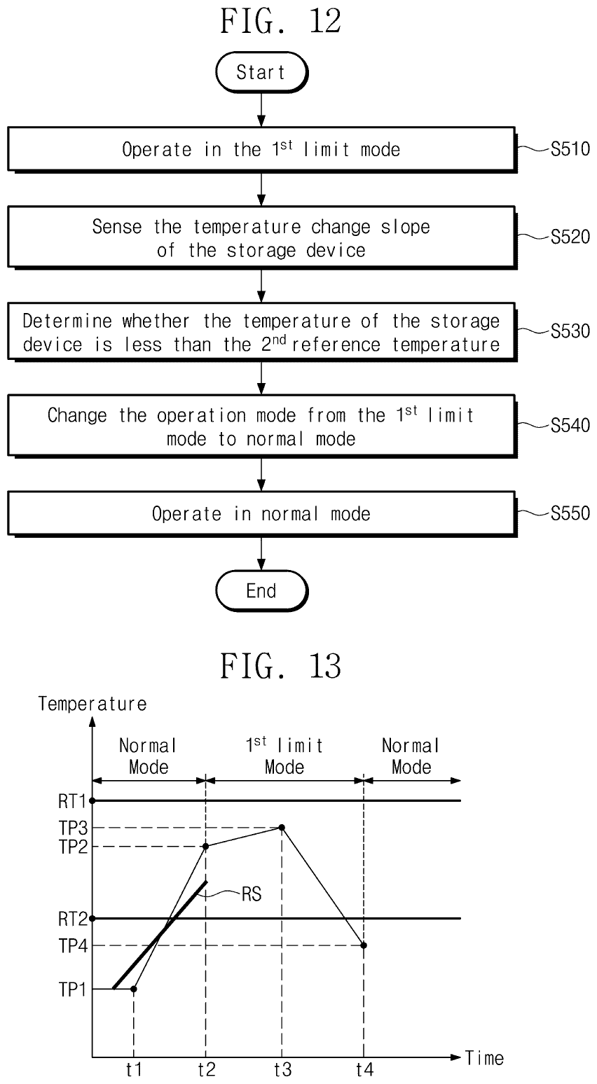

FIG. 12 is a flowchart illustrating an operation of a storage device of FIG. 1. Through the flowchart of FIG. 12, the storage device may change the operation mode of the storage device from the first limit mode to the normal mode. For example, as the storage device operates in the first limit mode, the temperature of the storage device may decrease; in this case, the storage device may change the operation mode from the first limit mode to the normal mode.

Referring to FIGS. 1, 2, and 12, in operation S510, the storage device 100 may operate in the first limit mode. In operation S520, the temperature sensor 130 may measure the temperature of the storage device 100 in the first limit mode so as to be provided to the mode manager 113.

In operation S530, the storage device 100 may determine whether the temperature of the storage device 100 in the first limit mode is smaller than the second reference temperature. For example, the mode manager 113 may determine whether the temperature of the storage device 100 measured by the temperature sensor 130 is smaller than the second reference temperature. For example, the second reference temperature may be used as a reference for determining whether to change the operation mode of the storage device 100. For example, the second reference temperature may be used as a reference for determining whether to change the operation mode of the storage device 100 from the first limit mode to the normal mode.

FIG. 13 is a diagram for describing operation S530 of FIG. 12. In the graph of FIG. 13, the horizontal axis represents a time, and the vertical axis represents a temperature of a storage device. Time intervals between first, second, third, and fourth time points t1, t1, t2, t3, and t4 may be periods in which a temperature sensor measures a temperature of the storage device.

Below, for convenience of description, it is assumed that a temperature increases as the storage device performs an operation or a task. However, the present disclosure is not limited thereto. For example, the storage device may operate in various ways depending on various use environments and/or a user/use scenarios.

At the first time point t1, the storage device 100 may operate in the normal mode. At the second time point t2, the storage device 100 may sense the temperature change slope of the storage device 100; when the temperature change slope of the storage device 100 is greater than or equal to the reference slope RS, the storage device 100 may change the operation mode of the storage device 100 from the normal mode to the first limit mode. At the third time point t3, the storage device 100 may operate in the first limit mode.

At the fourth time point t4, the temperature sensor 130 may measure the temperature of the storage device 100 in the first limit mode so as to be provided to the mode manager 113. The mode manager 113 may determine whether the temperature of the storage device 100 in the first limit mode measured by the temperature sensor 130 is greater than or equal to the second reference temperature RT2.

When the temperature of the storage device 100 in the first limit mode measured at the fourth time point t4 is smaller than the second reference temperature RT2, the mode manager 113 may change the operation mode of the storage device 100. The mode manager 113 may change the operation mode of the storage device 100 from the first limit mode to the normal mode. At the fourth time point t4, the storage device 100 may operate in the normal mode.

According to some implementations of the present disclosure, a storage device may operate based on various operation modes, depending on a temperature change slope or a temperature. Depending on the operation mode, the storage device may control a portion of the performance of the storage device or some of tasks which the storage device performs. Through the above control of the storage device, a temperature of the storage device may be prevented from sharply increasing, and the reduction of performance of the storage device may be prevented. Accordingly, storage devices with improved performance, and operation methods thereof, are provided.

While this disclosure contains many specific implementation details, these should not be construed as limitations on the scope of what may be claimed. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

While the present disclosure has been described with reference to various examples, it will be apparent to those of ordinary skill in the art that various changes and modifications may be made thereto without departing from the spirit and scope of the present disclosure.

What is claimed is:

1. An operation method of a storage controller, the method comprising:
obtaining a first temperature of a storage device operating in a normal mode, wherein the first temperature is measured by a temperature sensor;
determining a temperature change slope of the storage device based on the first temperature; and
based on the temperature change slope being greater than or equal to a reference slope, changing an operation mode of the storage device from the normal mode to a first limit mode,
based on the operation mode being the first limit mode, selectively throttling one or more tasks of the storage device.

2. The method of claim 1, comprising:
obtaining a second temperature of the storage device operating in the first limit mode, wherein the second temperature is measured by the temperature sensor.

3. The method of claim 2, comprising:
based on the second temperature of the storage device being greater than or equal to a first reference temperature, changing the operation mode of the storage device from the first limit mode to a second limit mode, and
based on the operation mode being the second limit mode, throttling or terminating all tasks of the storage device.

4. The method of claim 2, comprising:
based on the second temperature of the storage device being smaller than a first reference temperature and being greater than or equal to a second reference temperature, maintaining the first limit mode as the operation mode of the storage device.

5. The method of claim 2, comprising:
based on the second temperature of the storage device being smaller than a second reference temperature, changing the operation mode of the storage device from the first limit mode to the normal mode.

6. The method of claim 1, comprising determining the one or more tasks based on the temperature change slope.

7. An operation method of a storage controller, the method comprising:
periodically sensing a temperature of a storage device;
obtaining a first temperature of the storage device operating in a normal mode, wherein the first temperature is measured by a temperature sensor;
determining a temperature change slope of the storage device based on the first temperature;
based on the temperature change slope being greater than or equal to a reference slope, changing an operation mode of the storage device from the normal mode to a first limit mode; and
based on the operation mode being the first limit mode, selectively throttling one or more tasks performed in the first limit mode,
wherein selectively throttling the one or more tasks comprising selecting the one or more tasks, from among a plurality of tasks performed by the storage device, based on the temperature change slope.

8. The method of claim 7, selecting the one or more tasks comprises:
determining a first throttling reference slope range, to which the temperature change slope belongs, from among a plurality of throttling reference slope ranges;
determining a first priority level corresponding to the first throttling reference slope range; and
selecting the one or more tasks based on the one or more tasks having a priority level lower than or equal to the first priority level.

9. The method of claim 7, wherein the plurality of tasks comprise a plurality of external tasks and a plurality of internal tasks, and
wherein the one or more tasks comprise at least one of the plurality of internal tasks.

10. The method of claim 9, wherein the plurality of internal task includes at least one of wear-leveling, garbage collection, read reclaim, patrol read, and periodic refresh.

11. The method of claim 7, wherein the plurality of tasks comprise a plurality of external tasks and a plurality of internal tasks, and
wherein the one or more tasks comprise at least one of the plurality of external tasks.

12. A storage device comprising:
a temperature sensor configured to measure a temperature of the storage device; and
a storage controller including a mode manager configured to control an operation mode of the storage device,
wherein the mode manager is configured to:
receive a first temperature of the storage device operating in a normal mode, the first temperature received from the temperature sensor;
determine a temperature change slope of the storage device based on the first temperature;
based on the temperature change slope being greater than or equal to a reference slope, change the operation mode of the storage device from the normal mode to a first limit mode; and
based on the operation mode being the first limit mode, selectively throttling one or more tasks of the storage device.

13. The storage device of claim 12, wherein the mode manager is configured to:
receive a second temperature of the storage device operating in the first limit mode, wherein the second temperature is measured by the temperature sensor.

14. The storage device of claim 13, wherein the mode manager is configured to:
based on the second temperature being greater than or equal to a first reference temperature, change the operation mode of the storage device from the first limit mode to a second limit mode, and
based on the operation mode being the second limit mode, throttle or terminate all tasks of the storage device.

15. The storage device of claim 13, wherein the mode manager is configured to:
based on the second temperature being smaller than a first reference temperature and greater than or equal to a second reference temperature, maintain the first limit mode as the operation mode of the storage device.

16. The storage device of claim 13, wherein the mode manager is configured to:
based on the second temperature being smaller than a second reference temperature, change the operation mode of the storage device from the first limit mode to the normal mode.

17. The storage device of claim 12, wherein the mode manager is configured to determine the one or more tasks based on the temperature change slope.

18. The storage device of claim 12, wherein the mode manager is configured to:
determine a first throttling reference slope range, to which the temperature change slope belongs, from among a plurality of throttling reference slope ranges;
determine a first priority level corresponding to the first throttling reference slope range; and
select the one or more tasks based on the one or more tasks having a priority level lower than or equal to the first priority level.

19. The storage device of claim 12, wherein a plurality of tasks performed by the storage device comprises a plurality of external tasks and a plurality of internal tasks, and
wherein the one or more tasks comprise at least one of the plurality of internal tasks.

20. The storage device of claim 12, wherein the plurality of tasks comprise a plurality of external tasks and a plurality of internal tasks, and
wherein the one or more tasks comprise at least one of the plurality of external tasks.
